(19) United States
(12) Patent Application Publication
(10) Pub. No.: US 2020/0086422 A1
(43) Pub. Date: Mar. 19, 2020

(54) AXIALLY ADJUSTABLE LIGHT SPOT SYSTEM AND METHOD THEREOF

(71) Applicant: TOPAPEX OPTRONICS TECHNOLOGY CO.,LTD., Taipei (TW)

(72) Inventor: Hung-Tu LU, Taipei (TW)

(21) Appl. No.: 16/559,452

(22) Filed: Sep. 3, 2019

(30) Foreign Application Priority Data
Sep. 17, 2018 (TW) 107132561

(51) Int. Cl. B23K 26/082; B23K 26/06; B23K 26/70

(52) U.S. Cl. CPC B23K 26/082; B23K 26/0643; B23K 26/703; B23K 26/0665; B23K 26/0648

(57) ABSTRACT

The present invention discloses a method used for an axially adjustable light spot applied on an object and the steps thereof comprise of: (a) providing a light to generate an initial light spot; (b) setting up an optical component in order to direct the initial light spot to an application point of an object to form a projection light spot; (c) providing a driving unit to drive the optical component in order to adjust the projection light spot such that the projection light spot is the same or different in angle from the initial light spot; (d) providing a moving unit to selectively change a position of the projection light spot applied at the application point of the object. The present invention further provides an axially adjustable light spot system.

### FIELD OF THE INVENTION

The present invention is a technical field of a substrate processing, in particular, a method used for an axially adjustable light spot in order to change the direction of the light spot and a system thereof.

### BACKGROUND OF THE INVENTION

Conventional substrates (ex., glass, sapphire, silicon, gallium arsenide, ceramics, etc.) can be processed by heating, cutting, or drilling etc. with a laser light.

During processing, the laser maintains on a fixed light spot. Since the light spot may have an asymmetrical shape, different substrate shapes have different characteristics during substrate processing. Such as, the same light spot will have a different distribution of energy depending on its shape.

Different energy distributions may cause inconsistencies in the quality of light spot processing on the substrate.

In light of the above, the present invention proposes a method used for an axial adjustable light spot and system thereof for solving the aforementioned issue.

### SUMMARY OF THE INVENTION

The first purpose of the present invention is to provide a method used for an axially adjustable light spot in order to operate a light spot of a light applied onto an object with the same or a similar condition.

The second purpose of the present invention is to guide an initial light spot by an optical component to form a projection light spot at an application point of the object in accordance with the above-described method used for an axially adjustable light spot.

The third purpose of the present invention is to maintain a uniform processing condition/parameter applied to an object by adjusting a direction, an angle, a size, a focal point and/or an optical path of the light spot applied to the object in accordance with the above-described method used for an axial adjustable light spot.

The fourth purpose of the present invention is to provide the above-described method used for an axial adjustable light spot, and to adjust the angle of the light spot applied to an object and to move the object in conjunction with a moving unit, so that when the light is applied onto the object the light spot is consistent with the direction of advancement.

The fifth purpose of the present invention is to provide the above-described method used for an axially adjustable light spot and to provide a cooling unit that outputs a medium for reducing thermal energy generated when the light spot is applied onto the object.

The sixth purpose of the present invention is to provide the above-described method used for an axially adjustable light spot be able to use for processing a multi-dimensional object, such as a 2-dimensional object or a 3-dimensional object.

The seventh purpose of the present invention is to provide the above-described axial adjustable light spot system for implementing the aforementioned method used for an axially adjustable light spot.

In order to achieve the above and other purposes, the present invention provides a method used for an axially adjustable light spot to applied to an object. The steps of the method used for an axially adjustable light spot comprise of (a) providing a light to generate an initial light spot; (b) disposing an optical component in order to direct the initial light spot to form a projection light spot at an application point of the object, wherein at least one of a direction, an angle, a size, a focal point, and an optical path of the initial light spot is changed by the optical component; (c) providing a driving unit in order to drive the optical component to adjust the projection light spot such that the projection light spot is the same or different in angle from the initial light spot t; and (d) providing a moving unit to selectively change a position of the projection light spot applied at the application point of the object.

In order to achieve the above and other purposes, the present invention provides an axially adjustable light spot system applied to an object. The axis adjustable spot system comprises of a bearing unit, a light source unit, an optical component, a driving unit, and a processing unit. The bearing unit bears an object. The light source unit is disposed on a side of the bearing unit. A light with an initial light spot is generated by the light source unit. The optical component is disposed of in an optical path between the light source unit and the bearing unit. At least one of a direction, an angle, a size, a focal point and an optical path of the initial light spot is changed by the optical component in order to form a projection light spot. The driving unit is connected to the bearing unit and the optical component. A driving signal is received by the driving unit in order to adjust at least one of a shift amounts, a shift velocity, a rotation moment and a rotation speed of the bearing unit and the optical component. The processing unit is connected to the drive unit. The processing unit outputs the driving signal.

Comparing to the prior art, the method used for an axially adjustable light spot and system thereof are able to adjust the characteristic, e.g. the size, the direction etc. of the light spot arbitrarily in accordance with the needs of the object to be processed. This allows the light spot to be applied onto the object with consistency for characteristics such as a distribution of a light intensity, a distribution of a thermal energy, etc.

### BRIEF DESCRIPTION OF THE DRAWINGS

FIG. 1 is a schematic flow chart of the method used for an axially adjustable light spot according to a first embodiment of the present invention.

FIG. 2 is a schematic diagram illustrating the application of the light spot of FIG. 1 on an object of the present invention.

FIG. 3 is a schematic flow chart of the method used for an axially adjustable light spot according to the second embodiment of the present invention.

FIG. 4 is a schematic block diagram of the axially adjustable light spot system according to a third embodiment of the present invention.

FIG. 5 is a schematic block diagram of the axially adjustable light spot system according to the fourth embodiment of the present invention.

### DETAILED DESCRIPTION OF THE PREFERRED EMBODIMENTS

In order to fully understand the objectives, features, and functions of the present invention, the present invention is described in detail as follows by the following specific embodiments along with the accompanying figures.

In the present invention, “a” or “one” is used to describe the units, elements, and components described herein. This is done for the convenience of description only and provides a general meaning to the scope of the present invention. Therefore, unless stated otherwise, this description should be understood to include one, at least one, and more than one.

The context of the present invention are as follows. The terms “comprising”, “including”, “having” or “containing” are intended to encompass non-exclusive inclusions. For example, a component, structure, article, or device that comprises a plurality of elements is not limited to the elements listed herein but may include those not specifically listed but which are typically inherent in the element, structure, article, or device. Other requirements. In addition, the term “or” means an inclusive “or” unless it is specifically stated otherwise, rather than an exclusive “or”.

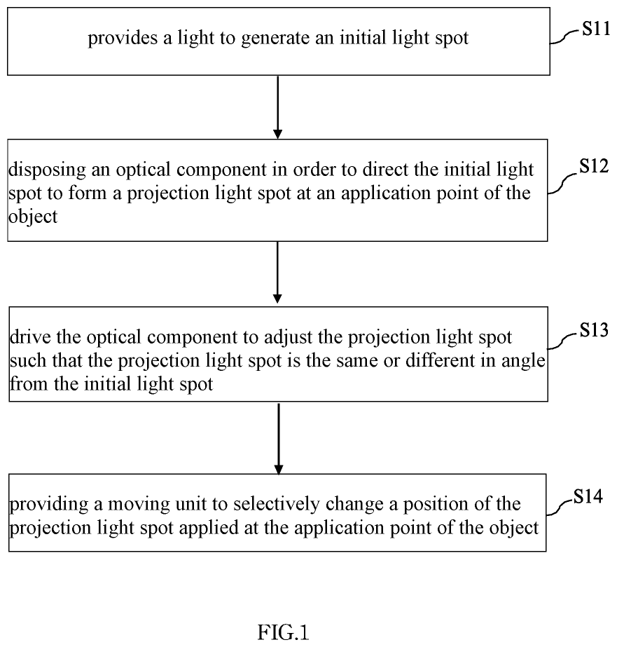

FIG. 1 is a schematic flow chart of the method used for an axially adjustable light spot according to a first embodiment of the present invention. In FIG. 1, the steps of the method used for an axially adjustable light spot are applied onto an object, for example, the object may be a substrate, and a material thereof may be glass, sapphire, silicon, gallium arsenide, ceramics or etc.

The step S11 of the method used for an axially adjustable light spot provides a light to generate an initial light spot. Wherein the light may be a visible light or an invisible light and the light may be, for example, various types of laser light etc.; a pattern shape of the initial light spot may be shaped of rectangular, square, circular, star-shaped, heart-shaped, ellipse-shaped, water-drop-shaped and more. The pattern shape of the initial light spot may be an asymmetrical shape or an asymmetrical shape as well other than the aforementioned symmetrical shape. Herein, the initial light spot is referred to the pattern generated by the light.

In step S12, disposing an optical component in order to direct the initial light spot to form a projection light spot at an application point of the object. Herein, the projection light spot is referred to the pattern generated by the light projected on the object. Wherein a direction, an angle, a size, a focal point, and an optical path of the initial light spot is changed by the optical component.

In step S13, providing a driving unit in order to drive the optical component to adjust the projection light spot such that the projection light spot is the same or different in angle from the initial light spot. The driving unit is able to adjust the projection light spot by, for example, rotating or moving the optical component. In another embodiment, the light may also be driven by the drive unit to perform a rotating motion.

In step S14, providing a moving unit to selectively change a position of the projection light spot applied at the application point of the object. Herein, because the size of the object is much larger than the size of the projection light spot. Therefore, the projection light spot is applied only at a point or in an area on the object actually. In this embodiment, whether a point or an area is collectively referred to as an “application point” in order to indicate the position where the projection light spot applied onto the object substantially. Furthermore, a 2-dimensional movement of the object may be provided by the moving unit, such as an X-Y plane. The moving unit may be driven by the drive unit such that the moving unit is moved toward an X-axis, a Y-axis, a direction of a component thereof, or the moving unit is rotated with an angle. In another embodiment, the moving unit may not move, but rather a movement of the light to achieve the purpose of changing the position at which the light spot is projected onto the object.

The aforementioned effects may be heating, cutting or drilling, which are respectively stated as follows:

Heating is referred to the fact that when the projection light spot is irradiated onto an application point of the object, the irradiated region temperature is higher than a temperature of a region un-irradiated by the other non-projection light spot. The reason resulting in an increasing temperature of the application point is that the light spot of the light emits a high energy and heats at the application point. This reason causes the temperature change at the application point. The distribution of the aforementioned change at the application point is related to the shape of the light spot (energy distribution). The action of heating can change the structure of the object by deterioration, dispersion, destruction of molecular arrangement, and more for example.

Cutting is referred to perform cutting an object according to the trajectory of the projection light spot movement, such that the object may be separated into the main substrate (herein it is referred to as a substrate to be used later) and a minor substrate (herein it is referred to as a waste, a scrap, etc.).

Drilling is referred to perform a drilling at the application point of the object based on the projection light spot in order to form a hole at the application point.

Regardless of the above applications, in the present embodiment, the initial light spot is adjusted by the optical element such that the projection light spot is able to be maintained in the same energy distribution state when in use.

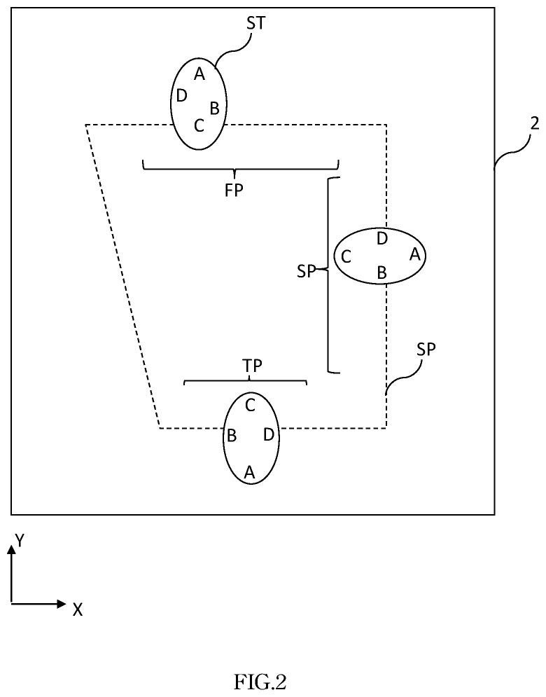

Reference is made to FIG. 2 together. In the present embodiment, a specific shape SP may be being cut on the object 2 by using the light spot ST. Wherein the shape of the light spot ST is elliptical. For the convenience of the subsequent description, the elliptical number is assigned, which are respectively labeled as A, B, C, and D. In the first position FP of the shape SP, the light spot ST is started from the Y-axis, and A, B, C, D are marked in the clockwise direction; in the second position SP of the shape SP, the light spot ST is started from the Y-axis, and D, A, B, C are marked in the clockwise direction respectively; in the third place TP of the shape SP, the light spot ST is started from the Y-axis, and C, D, A, B are marked in the clockwise direction respectively. Therefore, from the foregoing description, it can be understood that the mark B is always oriented in the direction in which the spot ST advances, so that the light spot ST has the same or similar light characteristics, ex: energy distribution, at any application points on each trajectory.

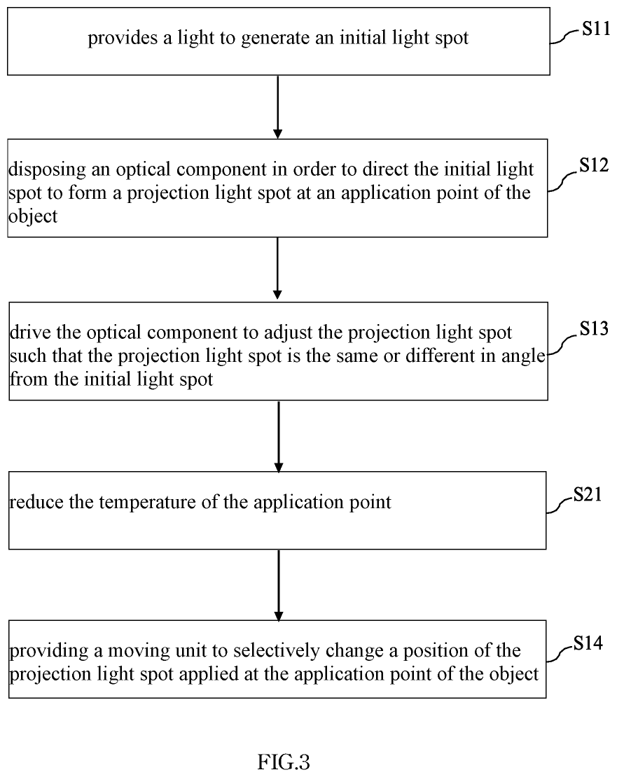

FIG. 3 is a schematic flow chart of the method used for an axial adjustable light spot according to a second embodiment of the present invention. In FIG. 3, the steps of the method used for an axially adjustable light spot further comprise step S21 in addition to the steps S11-S14 of the aforementioned first embodiment.

Steps S11-S14 has been described above, no longer to repeat.

Step S21 is to provide a cooling unit in order to reduce the temperature of the application point after the projection light spot is applied at the application point of the object. In another embodiment, the cooling unit is driven by the driving unit such that the cooling unit moves to any of the moving units.

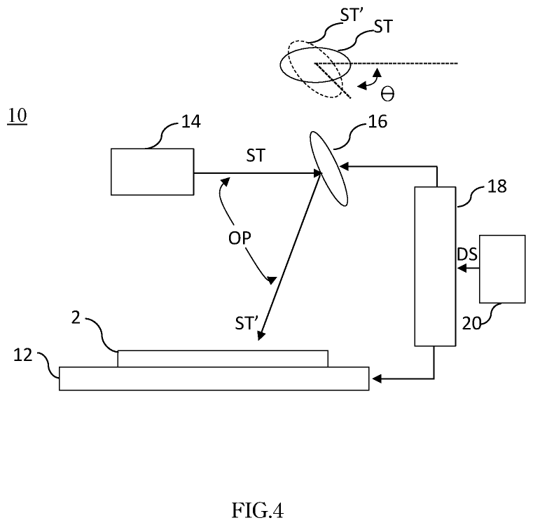

FIG. 4 is a schematic block diagram of the axially adjustable light spot system according to a third embodiment of the present invention In FIG. 4, the axially adjustable light spot system 10 is applied to an object 2.

The axially adjustable light spot system 10 includes a bearing unit 12, a light source unit 14, an optical component 16, a driving unit 18 and a processing unit 20.

The bearing unit 12 bears the object 2. For example, the bearing unit 12 may include a bearing stage (not shown) and a moving mechanism (such as a motor, a chain, a gear, etc.) (not shown). The bearing stage may be used for placing the object 2, and the moving mechanism may be used for changing the position of the bearing stage. In this embodiment, the moving mechanism allows the bearing stage to be moved in a plane, such as moved toward the X-axis, the Y-axis, or axial component thereof on the X-Y plane.

The light source unit 14 is disposed on an upper side of the bearing unit. In the present embodiment, it is an illustrative example that the light source unit 14 generates a laser light, and the laser light has an initial light spot ST. Wherein the shape of the initial light spot is a symmetrical shape or an asymmetrical shape, and the shape of the initial light spot may be a rectangle, square, circle, star, heart, ellipse, a drop, etc. for example.

The optical component 16 is disposed in an optical path OP between the light source unit 14 and the bearing unit 12, and the optical component 16 may be, for example, a convex lens, a concave lens, a beam splitter, a reflection mirror, etc. The optical component 16 can change the direction of the initial light spot ST (such as using the reflection mirror etc.), the angle of the initial light spot ST (such as using the reflection mirror etc.), the size of the initial light spot ST (such as using the concave lens, a convex lens, etc.), the focal point of the initial light spot ST (such as using a concave lens, the convex lens, etc.), the optical path of the initial light spot ST (such as using the reflection mirror, etc.) in order to form a projection light spot ST on the object 2. The drive unit 18 is connected to the bearing unit 12 and the optical component 16. The driving unit 18 receives a driving signal DS in order to adjust the shift amount, a shift velocity, a rotation amount and a rotation speed of the bearing unit 12 and the optical component 16. In the present embodiment, an operation of a rotation operation and/or a shift operation of the optical component 16 is performed through the driving unit 18 in order to form a projection light spot ST′ different in angle Θ from the initial light spot ST . . . . In another embodiment, the light source unit 14 may be connected to the driving unit 18. A shift amount, a shift velocity, a rotation amount and a rotation speed of the light source unit 14 may be adjusted by the driving unit 18. At this time, the driving unit 18 can decide whether to adjust the bearing unit 12 and the optical component 16.

The processing unit 20 is connected to the driving unit 18 and the processing unit 20 outputs the driving signal DS.

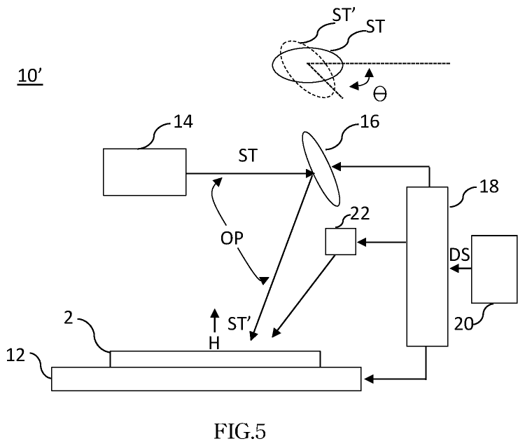

FIG. 5 is a schematic block diagram of the axially adjustable light spot system according to the fourth embodiment of the present invention. In FIG. 5, the axially adjustable light spot system 10′ is also applied to the object 2, and the axially adjustable light spot system 10′ includes the bearing unit 12, the light source unit 14, the optical assembly 16, the drive unit 18 and the processing unit 20 in the third embodiment. The cooling unit 22 is included as well.

The description of the bearing unit 12, the light source unit 14, the optical assembly 16, the drive unit 18 and the processing unit 20 is the same as mention above, no longer to repeat.

A cooling unit 22 is disposed on an upper side of the bearing unit 12, for example, the cooling unit 22 may be a nozzle. A medium (e.g., liquid, powder, gas, etc.) is generated by the cooling unit 22 in order to reduce a heat energy H generated by the projection light spot ST′ applied onto the object 2.

The present invention is disclosed in the abovementioned description by several preferred embodiments, but it is supposed to be comprehended by those who are skilled in the art that the embodiments are used only to illustrate the present invention rather than restrict the scope of the present invention. It should be noted that any equivalent variance or replacement in the embodiments shall be covered by the scope of the present invention. Therefore, what is claimed in the present invention shall be subject to the claims.

What is claimed is:

1. A method used for an axially adjustable light spot is applied to an object, and the method for adjusting an axially adjustable light comprises:
providing a light to generate an initial light spot;
disposing an optical component in order to direct the initial light spot to form a projection light spot at an application point of the object, wherein at least one of a direction, an angle, a size, a focal point, and an optical path of the initial light spot is changed by the optical component;
providing a driving unit in order to drive the optical component to adjust the projection light spot such that the projection light spot is the same or different in angle from the initial light spot; and
providing a moving unit to selectively change a position of the projection light spot applied at the application point of the object.

2. The method used for an axially adjustable light spot according to claim 1 further comprises of providing a cooling unit to reduce the temperature of the application point after the projection light spot is applied onto the application point of the object.

3. The method used for an axially adjustable light spot according to claim 2, wherein the cooling unit is driven by the driving unit such that the cooling unit is moved to any places of the moving units.

4. The method used for an axially adjustable light spot according to claim 1, wherein the moving unit is driven by the driving unit such that the moving unit is moved toward an X-axis, a Y-axis or a component direction thereof, or the moving unit is rotated with an angle.

5. The method used for an axially adjustable light spot according to claim 1, wherein the light is driven to rotate by the driving unit in order to selectively change the position of the projection light spot on the object.

6. An axially adjustable light spot system applied to an object, and the axially adjustable light spot system comprises:
a bearing unit bearing the object;
a light source unit disposed on a side of the bearing unit, and a light with an initial light spot is generated by the light source unit;
an optical component disposed of in an optical path between the light source unit and the bearing unit, at least one of a direction, an angle, a size, a focal point and an optical path of the initial light spot is changed by the optical component in order to form a projection light spot;
a driving unit connected to the bearing unit and the optical component, and a driving signal is received by the driving unit in order to adjust at least one of a shift amounts, a shift velocity, a rotation moment and a rotation speed of the bearing unit and the optical component; and
a processing unit connected to the driving unit, and the processing unit outputs the driving signal.

7. The axially adjustable light spot system according to claim 6, wherein the light source unit is connected to the driving unit, and at least one of a shift amounts, a shift velocity, a rotation amount and a rotation speed of the light source unit is adjusted by the driving unit.

8. The axially adjustable light spot system according to claim 6, wherein at least one operation of a rotation and a shift of the optical component is performed through the driving unit in order to form a projection light spot different in angle from the initial light spot.

9. The axial adjustment spot system according to claim 6, further comprises a cooling unit disposed on a side of the bearing unit, and a medium is generated by the cooling unit in order to reduce a heat energy generated by the projection light spot applied onto the object.

10. The axial adjustment spot system according to claim 8, further comprises a cooling unit disposed on a side of the bearing unit, and a medium is generated by the cooling unit in order to reduce a heat energy generated by the projection light spot applied onto the object.

11. The axially adjustable light spot system according to claim 9, wherein the cooling unit is connected to the driving unit, and one operation of a rotation and a shift of the cooling unit is performed by the driving unit.
